(19) United States
(12) Patent Application Publication
(10) Pub. No.: US 2026/0119036 A1
(43) Pub. Date: Apr. 30, 2026

(54) COMPRESSION RATIO BY USING PATTERN-BASED DATA DEDUPLICATION IN MEMORY DEVICE

(71) Applicant: Micron Technology, Inc., Boise, ID (US)

(72) Inventors: Rishabh DUBEY, Agrate Brianza (IT); Angelo Alberto ROVELLI, Agrate Brianza (IT); Daniele BALLUCHI, Cernusco Sul Naviglio (IT); Nicola CORNA, Gorle (IT); Nicola DEL GATTO, Cassina De' Pecchi (IT); Massimiliano PATRIARCA, Milano (IT)

(21) Appl. No.: 19/316,741

(22) Filed: Sep. 2, 2025

Related U.S. Application Data
(60) Provisional application No. 63/713,909, filed on Oct. 30, 2024.

(51) Int. Cl. G06F 3/06

(52) U.S. Cl. CPC G06F 3/0608; G06F 3/0641; G06F 3/0659; G06F 3/0673

(57) ABSTRACT

A memory device includes a memory cache to store write data comprising a plurality of data segments; a pattern database configured to store one or more data patterns; a deduplication engine configured to: identify whether a pattern of a data segment matches any data pattern, based on the pattern of the data segment matching any data pattern, identify the data segment as a duplicated data segment, remove the duplicated data segment from the write data to generate deduplicated write data, identify a pattern reference corresponding to a matching pattern that matches the pattern of the data segment, and generate a deduplication information including the pattern reference; a compression engine configured to compress the deduplication information and the deduplicated write data; and a memory array configured to store compressed deduplication information and compressed deduplicated write data.

### CROSS-REFERENCE TO RELATED APPLICATION

This Patent Application claims priority to U.S. Provisional Ser. No. 63/713,909, filed on Oct. 30, 2024, entitled “IMPROVED COMPRESSION RATIO BY USING PATTERN-BASED DATA DEDUPLICATION IN MEMORY DEVICE,” and assigned to the assignee hereof. The disclosure of the prior Application is considered part of and is incorporated by reference into this Patent Application.

### TECHNICAL FIELD

The present disclosure generally relates to memory devices, memory device operations, and, for example, to improved compression ratios by using pattern-based data deduplication.

### BACKGROUND

Memory devices are widely used to store information in various electronic devices. A memory device includes memory cells. A memory cell is an electronic circuit capable of being programmed to a data state of two or more data states. For example, a memory cell may be programmed to a data state that represents a single binary value, often denoted by a binary “1” or a binary “0.” As another example, a memory cell may be programmed to a data state that represents a fractional value (e.g., 0.5, 1.5, or the like). To store information, an electronic device may write to, or program, a set of memory cells. To access the stored information, the electronic device may read, or sense, the stored state from the set of memory cells.

Various types of memory devices exist, including random access memory (RAM), read only memory (ROM), dynamic RAM (DRAM), static RAM (SRAM), synchronous dynamic RAM (SDRAM), ferroelectric RAM (FeRAM), magnetic RAM (MRAM), resistive RAM (RRAM), holographic RAM (HRAM), flash memory (e.g., NAND memory and NOR memory), and others. A memory device may be volatile or non-volatile. Non-volatile memory (e.g., flash memory) can store data for extended periods of time even in the absence of an external power source. Volatile memory (e.g., DRAM) may lose stored data over time unless the volatile memory is refreshed by a power source.

### BRIEF DESCRIPTION OF THE DRAWINGS

FIG. 1 is a diagram illustrating an example system capable of improving a compression ratio by using pattern-based data deduplication in a memory device.

FIG. 2A shows a memory device according to one or more implementations.

FIG. 2B shows example memory operations according to one or more implementations.

FIG. 2C shows a memory device according to one or more implementations.

FIG. 3 shows example memory operations according to one or more implementations.

FIG. 4A shows an example coding table for a deduplication header according to one or more implementations.

FIG. 4B shows an example deduplication header according to one or more implementations.

FIG. 5 shows a graph showing a compression ratio gain using pattern-based deduplication over using only LZ4 compression.

FIG. 6 is a flowchart of an example method associated with providing an improved compression ratio by using pattern-based data deduplication in a memory device.

FIG. 7 is a flowchart of an example method associated with providing an improved compression ratio by using pattern-based data deduplication in a memory device.

### DETAILED DESCRIPTION

Compression techniques, including data deduplication, are crucial for maximizing storage and bandwidth efficiency, particularly for cloud service providers (CSPs) and independent software vendors (ISVs) whose platforms manage large volumes of data at a host system, which may be a cloud-based and/or server-based data storage system. For example, the host system may be a data center. The host system may be accessed by a memory device (e.g., a user-side) to write date to and read data from the host system. Furthermore, the host system may include multiple hosts that can access or otherwise communicate with the memory device. Existing approaches employ host-side compression to categorize data into “hot” and “cold” tiers, with frequently accessed data remaining uncompressed for performance reasons, while infrequently accessed (“cold”) data is stored in a compressed state to save storage space and costs. However, traditional methods encounter several challenges.

CSPs and ISVs would like to offload compression responsibilities from the host system (e.g., from the hosts) to the memory device. However, complexities arise when offloading the compression responsibilities from the host system to the memory device, particularly for a multi-tenant system where multiple independent users may be accessing the same memory resources. Implementing compression directly on the memory device centralizes this process, but also necessitates efficient management of the compressed data, such as by using defragmentation and maintaining a compression table. The issue is compounded by the fact that memory devices, unlike host CPUs, are not typically optimized for complex data management tasks such as dynamic compression, decompression, and deduplication.

Further challenges exist when one seeks to improve an overall compression ratio through deduplication at a granular level. While finer granularity deduplication—for instance, at 64-byte blocks—can substantially increase deduplication efficacy, the finer granularity deduplication incurs a significant overhead. For every 64-byte block of data, an additional indirection entry must be managed in an indirection table (e.g., a pointer table) within the memory device, leading to an overhead that can undermine the very benefit provided by the improved compression. Moreover, compression at such small data blocks can produce unfavorable compression ratios, and increasing the block size to improve the compression ratio conversely decreases the deduplication rate.

In summary, there exists a technical conundrum of optimizing compression ratios through granular deduplication without incurring prohibitive overheads or impacts on performance caused by a need for additional indirection table management. There is a need for a mechanism that can efficiently manage deduplication and compression within a memory device, particularly in a manner that minimizes the need for additional indirection and overhead while also negotiating the trade-offs between block size for deduplication, overall compression ratio, and system performance.

Some implementations described herein effectively enhance the compression ratio through pattern-based data deduplication within a memory device. For example, a memory device may include a memory cache for storing write data, a pattern database, a deduplication engine for identifying and removing duplicated data segments using patterns from the database and creating a deduplication header, and a compression engine for compressing both the header and deduplicated write data. In some implementations, the memory device may also contain a memory array, such as DRAM, for storing the compressed deduplication header and the deduplicated write data, and a pointer table management circuit for managing a pointer table relevant to data segments.

In this way, some implementations may offer a technical improvement by transferring compression and deduplication operations to the memory device, away from a host CPU. Some implementations not only increase an efficiency of data storage through enhanced deduplication processes, but also facilitate a reduction in data storage footprint by optimizing a granularity of data segments for deduplication. Some implementations may further reduce system overhead by minimizing the indirection required for data access post-deduplication. Put another way, some implementations may further reduce system overhead by reducing a number of indirection entries needed to maintain an indirection table (e.g., a pointer table). Instead, a deduplication header may be generated for use in combination with the indirection table. The deduplication header may be used to track deduplicated data blocks without the need for creating an indirection entry for the deduplicated data blocks. The deduplication header may be stored in the memory array. In some implementations, the deduplication header may be compressed along with user data. Thus, larger data block sizes may be used for compression, which increases a compression ratio, while smaller data block sizes may be used for deduplication without increasing processing and storage overhead for managing the indirection table.

By executing pattern-based deduplication and compression in tandem, along with efficient deduplication header and indirection table management within the memory device, processing resources on the host can be conserved while optimizing memory utilization at the memory device. In addition, by offloading compression responsibilities from a data center, power consumption at the data center may be reduced, which may contribute to a sustainability of the data center by way of energy savings due to the large amount of processing offloaded from the data center.

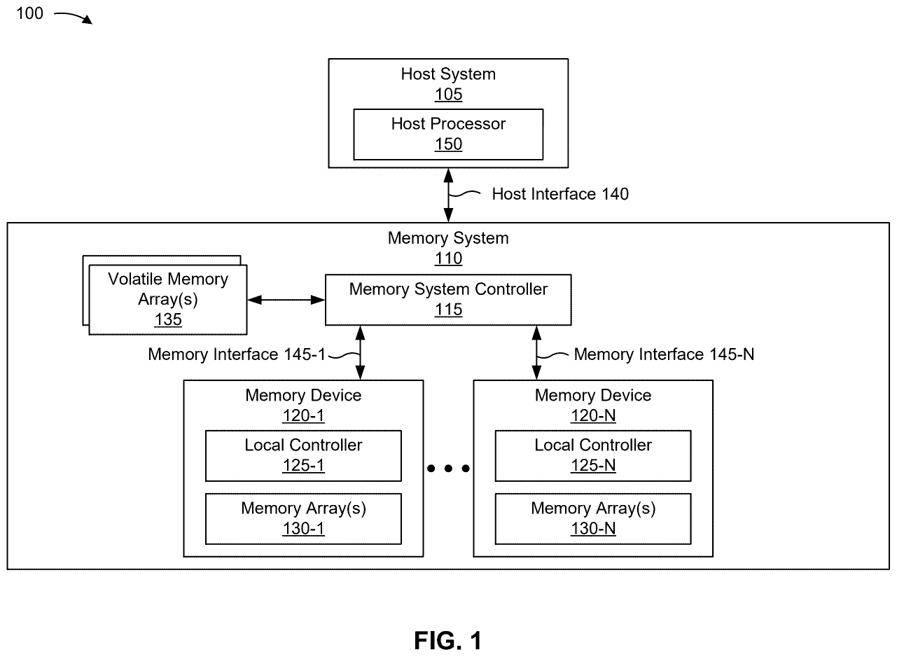

FIG. 1 is a diagram illustrating an example system 100 capable of improving a compression ratio by using pattern-based data deduplication in a memory device. The system 100 may include one or more devices, apparatuses, and/or components for performing operations described herein. For example, the system 100 may include a host system 105 and a memory system 110. The memory system 110 may include a memory system controller 115 and one or more memory devices 120, shown as memory devices 120-1 through 120-N (where N≥1). A memory device may include a local controller 125 and one or more memory arrays 130. The host system 105 may communicate with the memory system 110 (e.g., the memory system controller 115 of the memory system 110) via a host interface 140. The memory system controller 115 and the memory devices 120 may communicate via respective memory interfaces 145, shown as memory interfaces 145-1 through 145-N (where N≥1).

The system 100 may be any electronic device configured to store data in memory. For example, the system 100 may be a computer, a mobile phone, a wired or wireless communication device, a network device, a server, a device in a data center, a device in a cloud computing environment, a vehicle (e.g., an automobile or an airplane), and/or an Internet of Things (IoT) device. The host system 105 may include a host processor 150. The host processor 150 may include one or more processors configured to execute instructions and store data in the memory system 110. For example, the host processor 150 may include a central processing unit (CPU), a graphics processing unit (GPU), a field-programmable gate array (FPGA), an application-specific integrated circuit (ASIC), and/or another type of processing component.

The memory system 110 may be any electronic device or apparatus configured to store data in memory. For example, the memory system 110 may be a hard drive, a solid-state drive (SSD), a flash memory system (e.g., a NAND flash memory system or a NOR flash memory system), a universal serial bus (USB) drive, a memory card (e.g., a secure digital (SD) card), a secondary storage device, a non-volatile memory express (NVMe) device, an embedded multimedia card (eMMC) device, a dual in-line memory module (DIMM), a compute express link (CXL) memory module, and/or a random-access memory (RAM) device, such as a dynamic RAM (DRAM) device or a static RAM (SRAM) device.

The memory system controller 115 may be any device configured to control operations of the memory system 110 and/or operations of the memory devices 120. For example, the memory system controller 115 may include control logic, a memory controller, a system controller, an ASIC, an FPGA, a processor, a microcontroller, and/or one or more processing components. In some implementations, the memory system controller 115 may communicate with the host system 105 and may instruct one or more memory devices 120 regarding memory operations to be performed by those one or more memory devices 120 based on one or more instructions from the host system 105. For example, the memory system controller 115 may provide instructions to a local controller 125 regarding memory operations to be performed by the local controller 125 in connection with a corresponding memory device 120.

A memory device 120 may include a local controller 125 and one or more memory arrays 130. In some implementations, a memory device 120 includes a single memory array 130. In some implementations, each memory device 120 of the memory system 110 may be implemented in a separate semiconductor package or on a separate die that includes a respective local controller 125 and a respective memory array 130 of that memory device 120. The memory system 110 may include multiple memory devices 120. In some implementations, each memory device 120 may be a CXL memory device.

A local controller 125 may be any device configured to control memory operations of a memory device 120 within which the local controller 125 is included (e.g., and not to control memory operations of other memory devices 120). For example, the local controller 125 may include control logic, a memory controller, a system controller, an ASIC, an FPGA, a processor, a microcontroller, and/or one or more processing components. In some implementations, the local controller 125 may communicate with the memory system controller 115 and may control operations performed on a memory array 130 coupled with the local controller 125 based on one or more instructions from the memory system controller 115. As an example, the memory system controller 115 may be an SSD controller, and the local controller 125 may be a NAND controller.

A memory array 130 may include an array of memory cells configured to store data. For example, a memory array 130 may include a non-volatile memory array (e.g., a NAND memory array or a NOR memory array) or a volatile memory array (e.g., an SRAM array or a DRAM array). In some implementations, the memory system 110 may include one or more volatile memory arrays 135. A volatile memory array 135 may include an SRAM array and/or a DRAM array, among other examples. The one or more volatile memory arrays 135 may be included in the memory system controller 115, in one or more memory devices 120, and/or in both the memory system controller 115 and one or more memory devices 120. In some implementations, the memory system 110 may include both non-volatile memory capable of maintaining stored data after the memory system 110 is powered off and volatile memory (e.g., a volatile memory array 135) that requires power to maintain stored data and that loses stored data after the memory system 110 is powered off. For example, a volatile memory array 135 may cache data read from or to be written to non-volatile memory, and/or may cache instructions to be executed by a controller of the memory system 110.

The host interface 140 enables communication between the host system 105 (e.g., the host processor 150) and the memory system 110 (e.g., the memory system controller 115). The host interface 140 may include, for example, a Small Computer System Interface (SCSI), a Serial-Attached SCSI (SAS), a Serial Advanced Technology Attachment (SATA) interface, a Peripheral Component Interconnect Express (PCIe) interface, an NVMe interface, a USB interface, a Universal Flash Storage (UFS) interface, an eMMC interface, a double data rate (DDR) interface, a DIMM interface, and/or a CXL interface (e.g., a PCIe/CXL interface).

The memory interface 145 enables communication between the memory system 110 and the memory device 120. The memory interface 145 may include a non-volatile memory interface (e.g., for communicating with non-volatile memory), such as a NAND interface or a NOR interface. Additionally, or alternatively, the memory interface 145 may include a volatile memory interface (e.g., for communicating with volatile memory), such as a DDR interface.

Although the example memory system 110 described above includes a memory system controller 115, in some implementations, the memory system 110 does not include a memory system controller 115. For example, an external controller (e.g., included in the host system 105) and/or one or more local controllers 125 included in one or more corresponding memory devices 120 may perform the operations described herein as being performed by the memory system controller 115. Furthermore, as used herein, a “controller” may refer to the memory system controller 115, a local controller 125, or an external controller. In some implementations, the memory system controller 115 may be a CXL controller. In some implementations, a set of operations described herein as being performed by a controller may be performed by a single controller. For example, the entire set of operations may be performed by a single memory system controller 115, a single local controller 125, or a single external controller. Alternatively, a set of operations described herein as being performed by a controller may be performed by more than one controller. For example, a first subset of the operations may be performed by the memory system controller 115 and a second subset of the operations may be performed by a local controller 125. Furthermore, the term “memory apparatus” may refer to the memory system 110 or a memory device 120, depending on the context.

A controller (e.g., the memory system controller 115, a local controller 125, or an external controller) may control operations performed on memory (e.g., a memory array 130), such as by executing one or more instructions. For example, the memory system 110 and/or a memory device 120 may store one or more instructions in memory as firmware, and the controller may execute those one or more instructions. Additionally, or alternatively, the controller may receive one or more instructions from the host system 105 and/or from the memory system controller 115, and may execute those one or more instructions. In some implementations, a non-transitory computer-readable medium (e.g., volatile memory and/or non-volatile memory) may store a set of instructions (e.g., one or more instructions or code) for execution by the controller. The controller may execute the set of instructions to perform one or more operations or methods described herein. In some implementations, execution of the set of instructions, by the controller, causes the controller, the memory system 110, and/or a memory device 120 to perform one or more operations or methods described herein. In some implementations, hardwired circuitry is used instead of or in combination with the one or more instructions to perform one or more operations or methods described herein. Additionally, or alternatively, the controller may be configured to perform one or more operations or methods described herein. An instruction is sometimes called a “command.”

For example, the controller (e.g., the memory system controller 115, a local controller 125, or an external controller) may transmit signals to and/or receive signals from memory (e.g., one or more memory arrays 130) based on the one or more instructions, such as to transfer data to (e.g., write or program), to transfer data from (e.g., read), to erase, and/or to refresh all or a portion of the memory (e.g., one or more memory cells, pages, sub-blocks, blocks, or planes of the memory). Additionally, or alternatively, the controller may be configured to control access to the memory and/or to provide a translation layer between the host system 105 and the memory (e.g., for mapping logical addresses to physical addresses of a memory array 130). In some implementations, the controller may translate a host interface command (e.g., a command received from the host system 105) into a memory interface command (e.g., a command for performing an operation on a memory array 130).

In some examples, the system 100 may be associated with a CXL standard and/or protocol (e.g., the system 100 may utilize a CXL protocol to communicate between the host system 105, sometimes referred to as a CXL compliant host or simply a CXL host, and the memory system 110, sometimes referred to as a CXL compliant memory system or simply a CXL memory system). In that regard, the host system 105 may be a CXL host and the memory system 110 may be a CXL compliant memory system. The CXL host and the CXL compliant memory system may communicate via the host interface 140, which may include a CXL bus (e.g., a PCIe/CXL interface, an Ultra Accelerator link (UALink) interface, an Ethernet interface, an ultra-Ethernet interface, and/or a similar interface), among other examples.

In some examples, the memory system 110 may be a system that complies with the CXL standard and/or protocol, such as for a purpose of communicating with one or more host devices (e.g., the host system 105). CXL is an open standard that may enable high-speed CPU-to-device and CPU-to-memory interconnects designed to accelerate next-generation performance. The CXL standard may enable memory coherency between the CPU memory space and memory on attached devices, which allows resource sharing for higher performance, reduced software stack complexity, and lower overall system cost. CXL is designed to be an industry open standard for enabling an interface for high-speed communications. CXL technology utilizes the PCIe infrastructure, leveraging PCIe physical and electrical interfaces to provide an advanced protocol in areas such as input/output (I/O) protocol, memory protocol, and coherency interface.

In some implementations, one or more systems, devices, apparatuses, components, and/or controllers of FIG. 1 may be configured to a memory cache configured to store write data received from a host device, the write data comprising a plurality of data segments; a pattern database configured to store one or more data patterns; a deduplication engine configured to: receive a data segment, identify whether a pattern of the data segment matches any data pattern of the one or more data patterns, identify the data segment as a duplicated data segment, remove the duplicated data segment from the write data to generate deduplicated write data, and identify a pattern reference corresponding to a matching pattern of the one or more data patterns that matches the pattern of the data segment, and generate deduplication information including a detail associated with the duplicated data segment, wherein the detail includes the pattern reference; a compression engine configured to compress the deduplication information to generate compressed deduplication information and compress the deduplicated write data to generate compressed deduplicated write data;

and a memory array configured to store the compressed deduplication information and the compressed deduplicated write data.

In some implementations, one or more systems, devices, apparatuses, components, and/or controllers of FIG. 1 may be configured to a memory cache configured to store write data received from a host device, the write data comprising a plurality of data segments; a compression engine configured to compress the write data into compressed write data such that the plurality of data segments are compressed into a plurality of compressed data segments; a pattern database configured to store one or more data patterns; a deduplication engine configured to: receive a compressed data segment of the plurality of compressed data segments, identify whether a pattern of the compressed data segment matches any data pattern of the one or more data patterns, identify the compressed data segment as a duplicated compressed data segment, remove the duplicated compressed data segment from the plurality of compressed data segments to generate deduplicated compressed write data, and identify a pattern reference corresponding to a matching pattern of the one or more data patterns that matches the pattern of the compressed data segment, and generate deduplication information including a detail associated with the duplicated compressed data segment, wherein the detail includes the pattern reference; and a memory array configured to store the deduplication information and the deduplicated compressed write data.

In some implementations, one or more systems, devices, apparatuses, components, and/or controllers of FIG. 1 may be configured to receive write data comprising a plurality of data segments; identify whether a pattern of a data segment matches any data pattern of one or more data patterns stored in a pattern database; identify the data segment as a duplicated data segment; remove the duplicated data segment from the write data to generate deduplicated write data; identify a pattern reference corresponding to a matching pattern of the one or more data patterns that matches the pattern of the data segment; generate deduplication information including a detail associated with the duplicated data segment, wherein the detail includes the pattern reference; compress the deduplication information to generate compressed deduplication information; compress the deduplicated write data to generate compressed deduplicated write data; store the compressed deduplication information in a memory array; and store the compressed deduplicated write data in the memory array.

In some implementations, one or more systems, devices, apparatuses, components, and/or controllers of FIG. 1 may be configured to receive write data comprising a plurality of data segments; compress the write data into compressed write data such that the plurality of data segments are compressed into a plurality of compressed data segments; identify whether a pattern of a compressed data segment matches any data pattern of one or more data patterns stored in a pattern database; identify the compressed data segment as a duplicated compressed data segment; remove the duplicated compressed data segment from the plurality of compressed data segments to generate deduplicated compressed write data; identify a pattern reference corresponding to a matching pattern of the one or more data patterns that matches the pattern of the compressed data segment; generate deduplication information including a detail associated with the duplicated compressed data segment, wherein the detail includes the pattern reference; store the deduplication information in a memory array; and store the deduplicated compressed write data in the memory array. The number and arrangement of components shown in FIG. 1 are provided as an example. In practice, there may be additional components, fewer components, different components, or differently arranged components than those shown in FIG. 1. Furthermore, two or more components shown in FIG. 1 may be implemented within a single component, or a single component shown in FIG. 1 may be implemented as multiple, distributed components. Additionally, or alternatively, a set of components (e.g., one or more components) shown in FIG. 1 may perform one or more operations described as being performed by another set of components shown in FIG. 1.

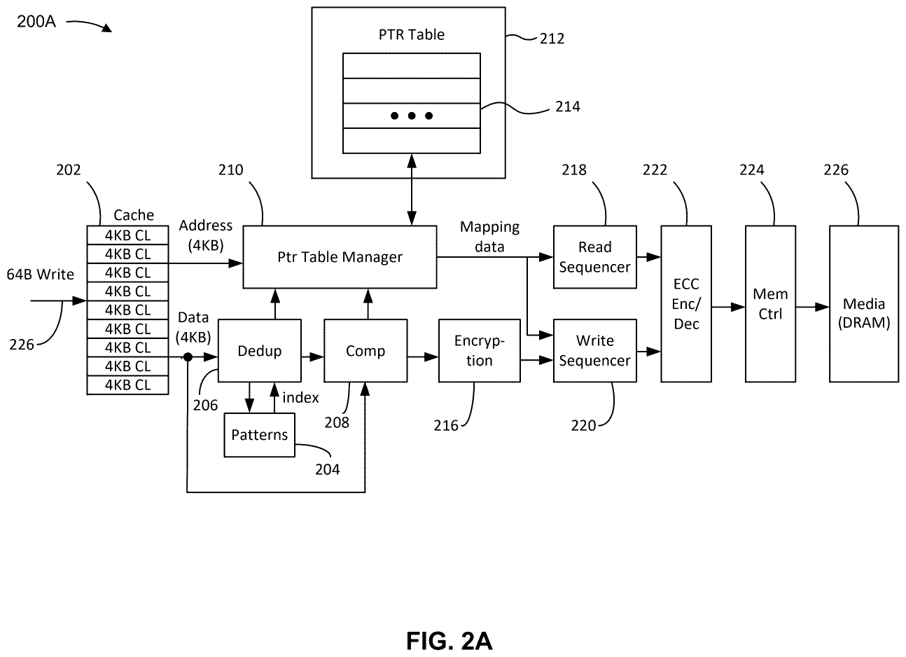

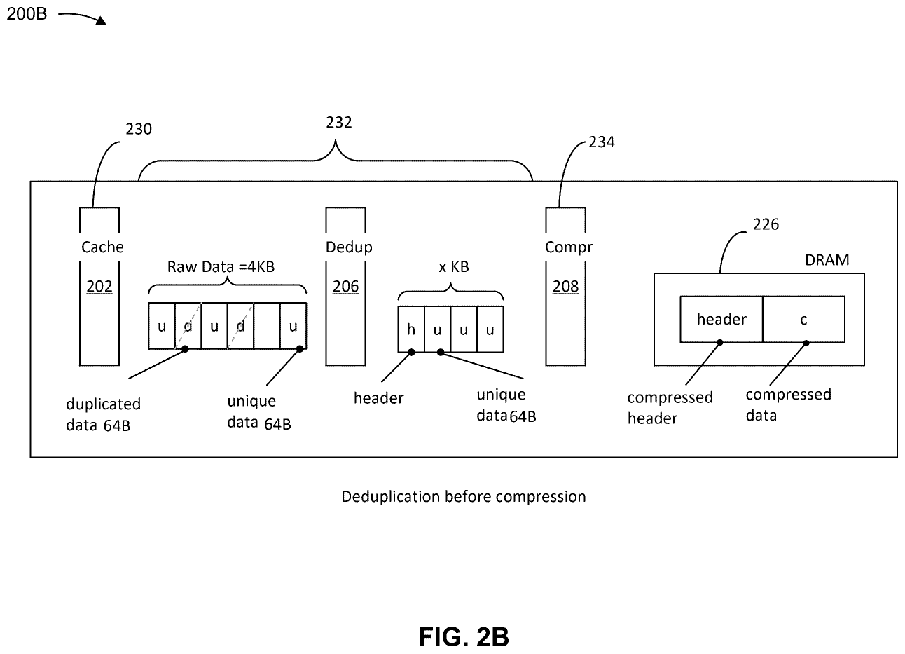

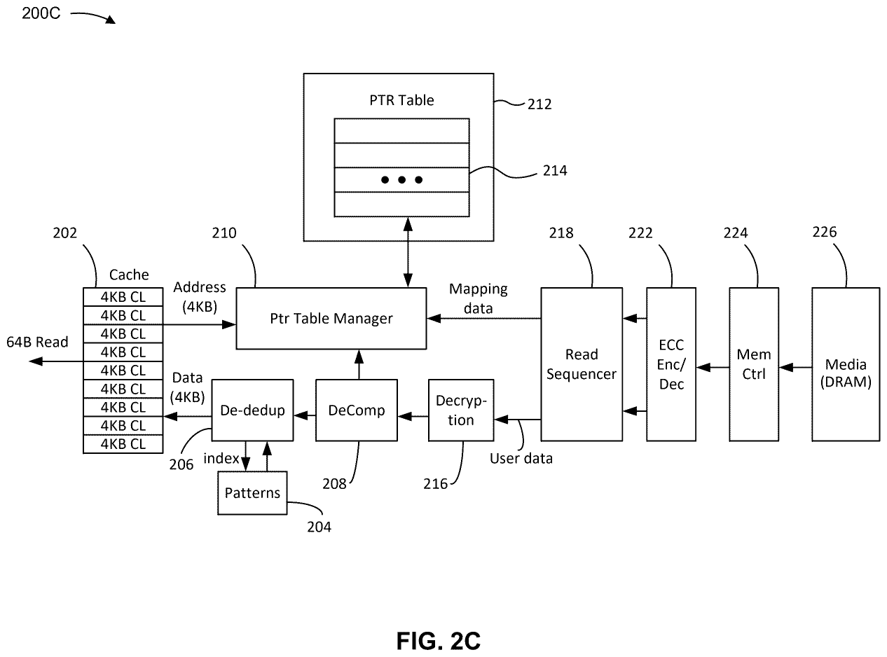

FIG. 2A shows a memory device 200A according to one or more implementations. The memory device 200A may correspond to the memory system 110 described in connection with FIG. 1. The memory device 200A may include a memory cache 202, a pattern database 204 configured to store one or more data patterns, a deduplication engine 206, a compression engine 208, a pointer table management circuit 210, a local cache 212 configured to store a pointer table 214 (e.g., PTR table), an encryption engine 216, a read sequencer 218, a write sequencer 220, an error correction code (ECC) encoder/decoder 222, a memory controller 224, and a memory array 226, such as a DRAM array. An “engine” may be a processing circuit comprising one or more processors, and may be configured to perform specific operations, such as deduplication, compression, encryption, or error correction. Directional arrows shown in FIG. 2A may correspond to a write operation.

In some implementations, the deduplication engine 206, the compression engine 208, the pointer table management circuit 210, the encryption engine 216, the read sequencer 218, the write sequencer 220, and the ECC encoder/decoder 222 may be part of the memory system controller 115 described in connection with FIG. 1.

The memory cache 202 may store write data (e.g., user data) received from a host device, such as a CXL host device. The memory device 200A may include an interface, such as a CXL interface, that is used to receive the write data from the host device. The host device may correspond to the host system 105 described in connection with FIG. 1. In some implementations, the host device may transmit, and the memory cache 202 may receive, the write data in data segments (e.g., data blocks) of 64 bytes (64 B), 128 bytes (128 B), 256 bytes (256 B), or higher. Other data sizes may be used.

However, in the example shown in FIG. 2, the memory cache 202 may receive the write data in data segments (e.g., data blocks) of 64 bytes. A size of the data segments may define a deduplication granularity (e.g., a deduplication block size) of the deduplication engine 206.

The memory cache 202 may include a plurality of cache lines (CLs). The memory cache 202 may be an SRAM cache. Each cache line may be 4 kilobytes (KB) in size. Other cache line sizes may be used, such as 2 KB, 6 KB, 8 KB, or higher. A cache line may be configured to temporarily accumulate data segments of write data until the cache line is full (e.g., until 4 KB of write data is accumulated). A size of the write data is a multiple of a data segment size. Once a cache line is filled, the cache line may be evicted, during which an address block is transmitted to the pointer table management circuit 210 and data segments stored in the cache line (e.g., a 4 KB block of data segments) are transmitted to the deduplication engine 206. Thus, cache lines may be sequentially evicted as cache lines are sequentially filled.

The address block may be a host physical memory address block that includes a host physical address (HPA) for each data segment of the plurality of data segments. The pointer table management circuit 210 may receive the host physical memory address block and generate the pointer table 214 for the write data based on the host physical memory address block. In some implementations, the host physical memory address block is a 4 KB-based address.

The deduplication engine 206 may receive the data segments evicted from a cache line (e.g., the 4 KB block of data segments). For each data segment in the 4 KB block of data segments, the deduplication engine 206 may identify whether a pattern of the data segment matches any data pattern of the one or more data patterns stored in the pattern database 204. For example, each data segment may have a deduplication block size of 64 B. Typically, a plurality of data patterns may be stored in the pattern database 204. The pattern database 204 may be stored in SRAM. The one or more data patterns may include fixed patterns and/or trained patterns (e.g., patterns detected by an artificial neural network via machine learning). Each pattern stored in the pattern database 204 may be associated with a pattern reference (e.g., a pattern index or other pattern indicator) that is unique to that pattern. The one or more data patterns may be uploaded to or updated in the pattern database 204 by firmware during a boot-time of the memory device 200A.

Based on the pattern of a data segment matching any data pattern of the one or more data patterns, the deduplication engine 206 may identify the data segment as a duplicated data segment, remove the duplicated data segment from the write data (e.g., from the 4 KB block of data segments) to generate deduplicated write data, and identify a pattern reference (e.g., a pattern index) corresponding to a matching pattern of the one or more data patterns that matches the pattern of the data segment. The deduplicated write data includes a plurality of non-duplicated data segments from the plurality of data segments (e.g., those data segments from the 4 KB block of data segments that do not match any data pattern in the pattern database 204).

In addition, the deduplication engine 206 may generate deduplication information that includes the pattern reference. For example, the deduplication engine 206 may generate deduplication information including a detail associated with the duplicated data segment. The detail may include the pattern reference (e.g., the pattern index). In some implementations, the deduplication engine 206 may generate a deduplication header including a header block associated with the duplicated data segment, where the header block includes the pattern reference. The detail may be the header block. Thus, the deduplication header may include a corresponding pattern reference for each data segment of the 4 KB block of data segments that is detected as a duplicated data segment. The deduplication header may include at least one of: a single deduplication identifier block and a single deduplication index block that includes a respective pattern reference corresponding to a single duplicated data segment; a multiple adjacent deduplication identifier block, a multiple adjacent deduplication index block that includes a respective pattern reference corresponding to multiple adjacent duplicated data segments, and a number indicator block that includes a number of multiple adjacent duplicated data segments corresponding to the multiple adjacent deduplication identifier block and the multiple adjacent deduplication index block; a single non-duplicated identifier block; and a multiple adjacent non-duplicated identifier block and a number indicator block that includes a number of multiple adjacent non-duplicated data segments.

The compression engine 208 may compress the deduplication header to generate a compressed deduplication header and may compress the deduplicated write data to generate compressed deduplicated write data. The compression engine 208 may perform a lossless compression, such as an LZ4 compression. The memory array 226 may store the compressed deduplication header and the compressed deduplicated write data.

The pointer table management circuit 210 may manage the pointer table 214 that includes a plurality of entries. Each entry of the plurality of entries may correspond to a respective non-duplicated data segment of the plurality of non-duplicated data segments. In other words, the pointer table management circuit 210 may generate an entry in the pointer table 214 for only those data segments that are determined by the deduplication engine 206 to be non-duplicated data segments, and may not generate an entry in the pointer table 214 for those data segments that are determined by the deduplication engine 206 to be duplicated data segments. Thus, overhead in managing the pointer table 214 may be reduced despite using a finer granularity for deduplication. In some implementations, the pointer table 214 may be an indirection table.

In some implementations, each entry of the plurality of entries maps an HPA to a device physical address (DPA) for a respective non-duplicated data segment. The HPA of a respective non-duplicated data segment may be determined from the host physical memory address block. The DPA may be a physical address of the memory array 226 in which the respective non-duplicated data segment is to be stored. Thus, the pointer table management circuit 210 may map an HPA of the respective non-duplicated data segment to the DPA in which the respective non-duplicated data segment is to be stored. The pointer table management circuit 210 may provide mapping data to the read sequencer 218 and the write sequencer 220.

In some implementations, the compression engine 208 may provide a length of the compressed deduplicated write data to the pointer table management circuit 210. The length of the compressed deduplicated write data may correspond to a compressed length of the 4 KB block of data segments after deduplication (e.g., after removal of duplicated data segments from the 4 KB block of data segments) and after compression, referred to as the compressed deduplicated write data. Accordingly, the compressed deduplicated write data is made up of compressed non-duplicated data segments. The pointer table management circuit 210 may, based on the length of the compressed deduplicated write data, allocate a respective media location within the memory array 226 to each compressed non-duplicated data segment, and associate the respective media location to a corresponding entry of the plurality of entries within the pointer table. Thus, the pointer table management circuit 210 may map the HPA of the respective non-duplicated data segment to the DPA in which the respective non-duplicated data segment is to be stored based on the length of the compressed deduplicated write data.

In some implementations, the encryption engine 216 may encrypt the compressed deduplication header and the compressed deduplicated write data, prior to storing the compressed deduplication header and the compressed deduplicated write data in the memory array 226.

During a write operation, the write sequencer 220 may write each compressed non-duplicated data segment provided in the compressed deduplicated write data to the respective media location within the memory array 226 (e.g., based on the mapping data).

During a read operation, the read sequencer 218 may read compressed non-duplicated data segments and the compressed deduplication header from the memory array 226 based on the mapping data.

The ECC encoder/decoder 222 may detect and correct errors in the compressed deduplicated write data prior to writing the compressed deduplicated write data to the respective media location within the memory array 226.

The memory controller 224 may correspond to the local controller 125 described in connection with FIG. 1. The memory controller 224 may access the memory array 226 to write the compressed deduplication header and the compressed deduplicated write data to respective media locations within the memory array 226 allocated to the compressed deduplication header and the compressed deduplicated write data.

In some implementations, the compression engine 208 may compress the write data (e.g., the 4 KB block of data segments) from a respective cache line to generate compressed write data. To ensure that the smallest payload is stored in the memory array 226, the memory controller 224 may evaluate a payload size of the write data, a payload size of the deduplicated write data, a payload size of the compressed write data, and a payload size of the compressed deduplicated write data, and store one of the write data, the deduplicated write data, the compressed write data, or the compressed deduplicated write data, having a smallest payload size, in the memory array 226. Alternatively, the compression engine 208 may evaluate the payload size of the write data, the payload size of the deduplicated write data, the payload size of the compressed write data, and the payload size of the compressed deduplicated write data, and determine which one of the write data, the deduplicated write data, the compressed write data, or the compressed deduplicated write data, having a smallest payload size, to store in the memory array 226. The compression engine 208 may indicate to the pointer table management circuit 210 which payload has the smallest payload size and a payload size of the smallest payload size for generating the pointer table 214.

In some implementations, an arrangement of the deduplication engine 206 and the compression engine 208 may be swapped, such that the compression engine 208 is arranged to receive the data segments evicted from a cache line (e.g., the 4 KB block of data segments), and the deduplication engine 206 may be arranged after the compression engine 208 to receive compressed write data from the compression engine 208.

Accordingly, the compression engine 208 may compress the write data (e.g., the 4 KB block of data segments) into compressed write data such that the plurality of data segments are compressed into a plurality of compressed data segments. Additionally, the deduplication engine 206 may receive the plurality of compressed data segments and perform deduplication based on each compressed data segment. For example, the deduplication engine 206 may evaluate a compressed data segment of the plurality of compressed data segments, and identify whether a pattern of the compressed data segment matches any data pattern of the one or more data patterns. The deduplication engine 206 may, based on the pattern of the compressed data segment matching any data pattern of the one or more data patterns, identify the compressed data segment as a duplicated compressed data segment, remove the duplicated compressed data segment from the plurality of compressed data segments to generate deduplicated compressed write data, and identify a pattern reference corresponding to a matching pattern of the one or more data patterns that matches the pattern of the compressed data segment. Additionally, the deduplication engine 206 may generate a deduplication header including a header block associated with the duplicated compressed data segment, where the header block includes the pattern reference.

The deduplication engine 206 may provide a length of the deduplicated compressed write data to the pointer table management circuit 210, and the pointer table management circuit 210 may, based on the length of the deduplicated compressed write data, allocate a respective media location within the memory array 226 to each non-duplicated compressed data segment within the deduplicated compressed write data, and associate the respective media location to a corresponding entry of the plurality of entries within the pointer table 214. The memory array 226 may store the deduplication header and the deduplicated compressed write data. For example, the write sequencer 220 may write each non-duplicated compressed data segment provided in the deduplicated compressed write data to the respective media location within the memory array 226.

In some implementations, the encryption engine 216 may also perform decryption. For example, the encryption engine 216 may perform decryption during a read operation. Likewise, the compression engine 208 may also perform decompression. For example, the compression engine 208 may perform decompression during the read operation. The deduplication engine 206 may also perform de-deduplication. For example, the deduplication engine 206 may perform de-deduplication during the read operation to reconstruct the user data. Thus, the memory operations described above may be reversed during the read operation.

As indicated above, FIG. 2A is provided as an example. Other examples may differ from what is described with regard to FIG. 2A.

FIG. 2B shows example memory operations 200B according to one or more implementations. The memory operations 200B may be performed by the memory device 200A described in connection with FIG. 2A. The memory operations 200B include a cache operation 230 performed by the memory cache 202, a deduplication operation 232 performed by the deduplication engine 206, and a compression operation 234 performed by the compression engine 208.

The cache operation 230 may include storing write data, received from a host device, in a cache line. The write data may include a plurality of data segments (e.g., 64-byte data segments). The cache operation 230 may further include evicting the write data stored in the cache line based on the cache line being filled. The write data may be raw data made up of a 4 KB block of data segments.

The deduplication operation 232 may include removing duplicated data segments from the write data such that only unique data (e.g., non-duplicated data segments) remain. By removing the duplicated data segments from the write data, deduplicated write data is generated. The deduplication operation 232 may include generating a deduplication header and appending the deduplication header to deduplicated write data to form an x-KB-sized packet.

The compression operation 234 may include compressing the deduplication header to generate a compressed deduplication header, and compressing the deduplicated write data to generate compressed deduplicated write data. The compressed deduplication header and the compressed deduplicated write data may be stored in a memory array, such as memory array 226.

As indicated above, FIG. 2B is provided as an example. Other examples may differ from what is described with regard to FIG. 2B.

FIG. 2C shows a memory device 200C according to one or more implementations. The memory device 200C may be similar to the memory device 200A described in connection with FIG. 2A, except directional arrows are reversed to correspond to a read operation. Thus, memory operations performed by memory device 200C are performed in reverse compared to the memory operations described in connection with the memory device 200A.

The memory device 200C may include the memory cache 202, the pattern database 204 configured to store one or more data patterns, the deduplication engine 206 (e.g., used as a de-deduplication engine), the compression engine 208 (e.g., used as a decompression engine), the pointer table management circuit 210, the local cache 212 configured to store the pointer table 214, the encryption engine 216 (e.g., used as a decryption engine), the read sequencer 218, the ECC encoder/decoder 222, the memory controller 224, and the memory array 226, such as a DRAM array.

A 64 B read access may be received from a host device. A 4 KB associated address is forwarded to the pointer table management circuit 210. If a local cache of the pointer table management circuit 210 already has the media address, then a user data read request is forwarded to the read sequencer 218. If the pointer table management circuit 210 does not find the media address in the local cache, the pointer table management circuit 210 may request the read sequencer 218 to read an entry of the pointer table 214, and then send a user data read request to the read sequencer 218 once the media address for the user data is known. The read sequencer 218 may retrieve the compressed deduplication header and the compressed deduplicated write data from the memory array 226 associated with the user data read request from the memory array 226. After reading the user data from the memory array 226, the user data is decrypted, uncompressed, and then un-deduplicated to generate the original 4 KB data payload.

For example, the compression engine 208 may receive the compressed deduplication header and the compressed deduplicated write data from the memory array 226 and perform decompression on the compressed deduplication header and the compressed deduplicated write data. The compression engine 208 may provide the deduplication header and the deduplicated write data to the deduplication engine 206.

The deduplication engine 206 may read the deduplicated write data to determine which data segments were removed during deduplication and perform de-deduplication. The deduplication engine 206 may provide a pattern reference associated with a duplicated data segment and retrieve the data pattern associated with the pattern reference from the pattern database 204. The retrieved data pattern may be used as a corresponding data segment that was removed during deduplication. Thus, the write data can be reconstructed during the read operation and may be provided to the memory cache 202 as read data. Once the memory cache 202 has the entire 4K data payload, the memory cache 202 transfers 64B to the host device. In other words, the entire 4K data payload may be transferred in 64B data segments.

As indicated above, FIG. 2C is provided as an example. Other examples may differ from what is described with regard to FIG. 2C.

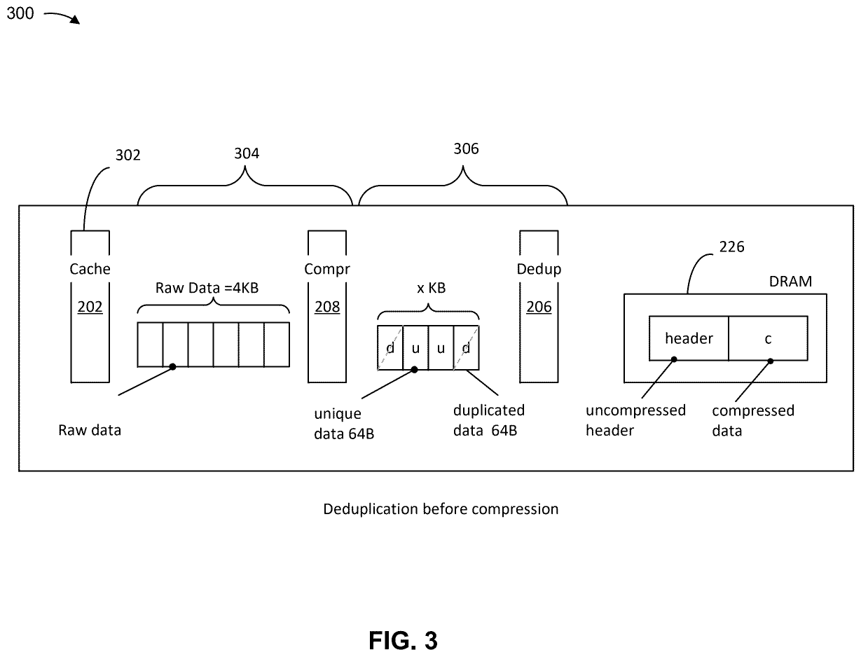

FIG. 3 shows example memory operations 300 according to one or more implementations. The memory operations 300 may be performed by the memory device 200A described in connection with FIG. 2A. However, an arrangement of the deduplication engine 206 and the compression engine 208 may be swapped such that compression engine 208 is arranged to receive the data segments evicted from a cache line (e.g., the 4 KB block of data segments), and the deduplication engine 206 may be arranged after the compression engine 208 to receive compressed write data from the compression engine 208. Thus, the memory operations 300 include a cache operation 302, a compression operation 304, and deduplication operation 306.

The cache operation 302 may include storing write data, received from a host device, in a cache line. The write data may include a plurality of data segments (e.g., 64-byte data segments). The cache operation 302 may further include evicting the write data stored in the cache line based on the cache line being filled. The write data may be raw data made up of a 4 KB block of data segments.

The compression operation 304 may include compressing the write data into compressed write data such that the plurality of data segments are compressed into a plurality of compressed data segments. The compressed write data may have a size of x KB.

The deduplication operation 306 may include performing deduplication based on each compressed data segment. For example, the deduplication engine 206 may evaluate a compressed data segment of the plurality of compressed data segments, and identify whether a pattern of the compressed data segment matches any data pattern of the one or more data patterns. The deduplication engine 206 may, based on the pattern of the compressed data segment matching any data pattern of the one or more data patterns, identify the compressed data segment as a duplicated compressed data segment, remove the duplicated compressed data segment from the plurality of compressed data segments to generate deduplicated compressed write data, and identify a pattern reference (e.g., a pattern index or a pattern indicator) corresponding to a matching pattern of the one or more data patterns that matches the pattern of the compressed data segment. Additionally, the deduplication engine 206 may generate a deduplication header including a header block associated with the duplicated compressed data segment, where the header block includes the pattern reference.

The deduplicated compressed write data may include a plurality of non-duplicated compressed data segments from the plurality of compressed data segments. The pointer table management circuit 210, while not shown in FIG. 3, may be configured to manage the pointer table 214 that includes a plurality of entries. Each entry of the plurality of entries may correspond to a respective non-duplicated compressed data segment of the plurality of non-duplicated compressed data segments. The pointer table management circuit 210 may be configured to not include an entry in the pointer table that corresponds to the duplicated compressed data segment. Each entry of the plurality of entries may map an HPA to a DPA for the respective non-duplicated compressed data segment. For example, the pointer table management circuit 210 may receive a host physical memory address block from the memory cache 202 and generate the pointer table 214 for the write data based on the host physical memory address block. The host physical memory address block may include an HPA for each data segment of the plurality of data segments.

The deduplication operation 306 may include providing a length of the deduplicated compressed write data to the pointer table management circuit 210. For example, the deduplication engine 206 may provide the length of the deduplicated compressed write data to the pointer table management circuit 210, and the pointer table management circuit 210 may, based on the length of the deduplicated compressed write data, allocate a respective media location within the memory array 226 to each non-duplicated compressed data segment within the deduplicated compressed write data, and associate the respective media location to a corresponding entry of the plurality of entries within the pointer table 214.

The memory array 226 may store the deduplication header and the deduplicated compressed write data.

As indicated above, FIG. 3 is provided as an example. Other examples may differ from what is described with regard to FIG. 3.

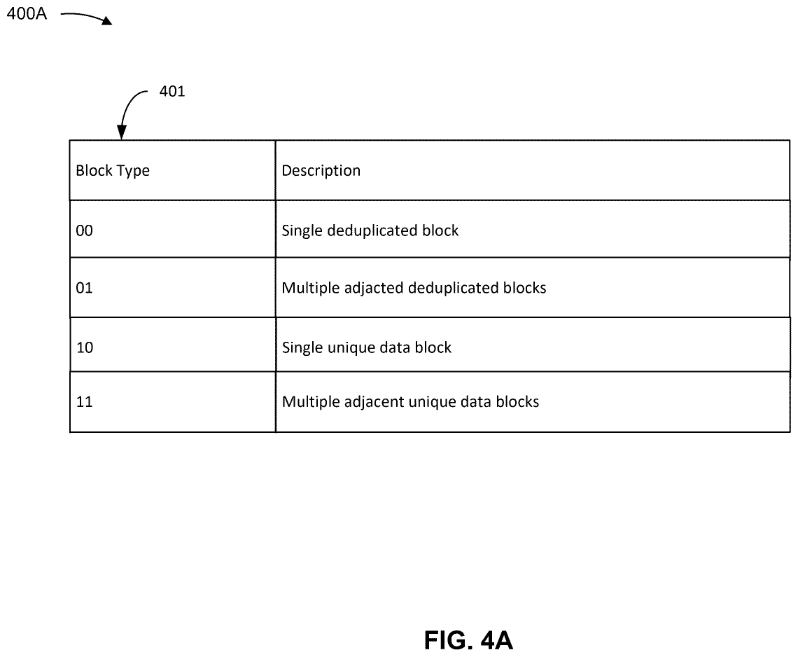

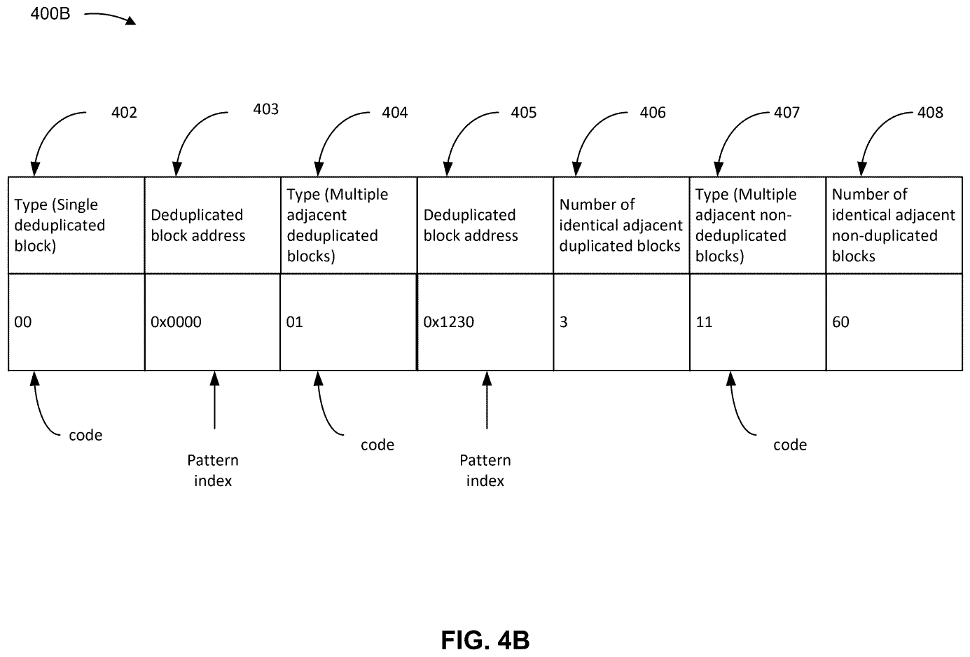

FIG. 4A shows an example coding table 400A for a deduplication header according to one or more implementations. Block codes 401 may be used to identify different block types within the deduplication header. The different block types may include a single deduplication identifier block, which may be identified by a block type code 00; a multiple adjacent deduplication identifier block, which may be identified by a block type code 01; a single non-duplicated identifier block, which may be identified by a block type code 10; and a multiple adjacent non-duplicated identifier block, which may be identified by a block type code 11. The deduplication header may be made up of one or more header blocks which identify how a plurality of data segments (e.g., the 4 KB block of data segments) are arranged.

The single deduplication identifier block may correspond to single duplicated data segment (e.g., a standalone duplicated data segment with no adjacent duplicated data segments of a same data pattern). The multiple adjacent deduplication identifier block may correspond to multiple adjacent duplicated data segments. For example, the multiple adjacent deduplication identifier block may be relevant when multiple adjacent data segments correspond to a same data pattern. The single non-duplicated identifier block may correspond to a single non-duplicated (e.g., unique) data segment (e.g., a standalone non-duplicated data segment with no adjacent non-duplicated data segments). The multiple adjacent non-duplicated identifier blocks may correspond to multiple adjacent non-duplicated data segments.

As indicated above, FIG. 4A is provided as an example. Other examples may differ from what is described with regard to FIG. 4A.

FIG. 4B shows an example deduplication header 400B according to one or more implementations. The deduplication header 400B may incorporate the block type codes described in connection with FIG. 4A.

The deduplication header 400B may include a single deduplication identifier block 402 with block type code 00, and a single deduplication index block 403 that includes a respective pattern reference corresponding to a single duplicated data segment. Blocks 402 and 403 are linked together and may be associated with a single duplicated data segment.

The deduplication header 400B may include a multiple adjacent deduplication identifier block 404 with block type code 01, a multiple adjacent deduplication index block 405 that includes a respective pattern reference corresponding to multiple adjacent duplicated data segments, and a number indicator block 406 that includes a number of multiple adjacent duplicated data segments that correspond to the respective pattern reference identified in the multiple adjacent deduplication index block 405. Blocks 404, 405, and 406 are linked together and may be associated with multiple adjacent duplicated data segments.

The deduplication header 400B may include a multiple adjacent non-duplicated identifier block 407 with block type code 11, and a number indicator block 408 that includes a number of multiple adjacent non-duplicated data segments. Blocks 407 and 408 are linked together and may be associated with multiple adjacent non-duplicated data segments.

As indicated above, FIG. 4B is provided as an example. Other examples may differ from what is described with regard to FIG. 4B.

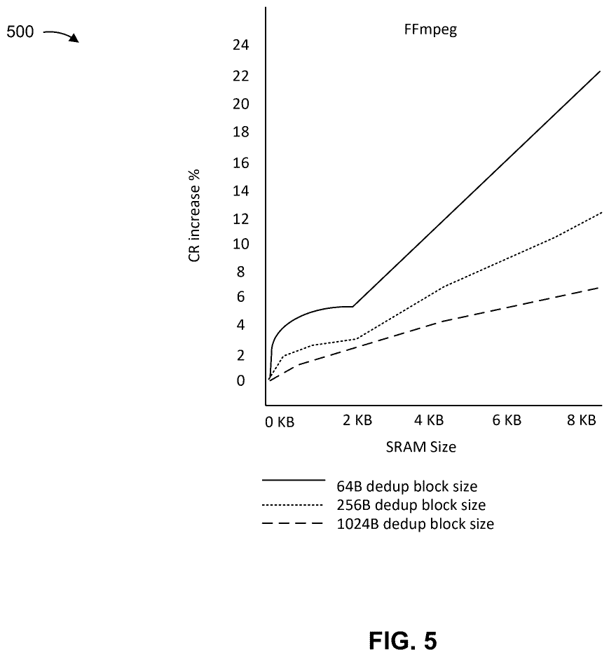

FIG. 5 shows a graph 500 showing a compression ratio (CR) gain using pattern-based deduplication over using only LZ4 compression (e.g., without the pattern-based deduplication). The pattern-based deduplication may be performed based on the implementations described herein. The graph 500 shows a compression ratio gain for different deduplication block sizes, including 64 B, 256 B, and 1024 B. The 64 B deduplication block size provides the highest CR gain over only using LZ4 compression. An SRAM size may be a size of a cache line of a memory cache (e.g., memory cache 202), which may include 2 KB, 4 KB, 6 KB, or 8 KB. The 8 KB cache line size provides the highest CR gain over only using LZ4 compression. Moreover, values include deduplication header overhead. Thus, using the pattern-based deduplication, as described herein, in combination with compression can yield significant benefit in increasing the compression ratio over using only LZ4 compression.

As indicated above, FIG. 5 is provided as an example. Other examples may differ from what is described with regard to FIG. 5.

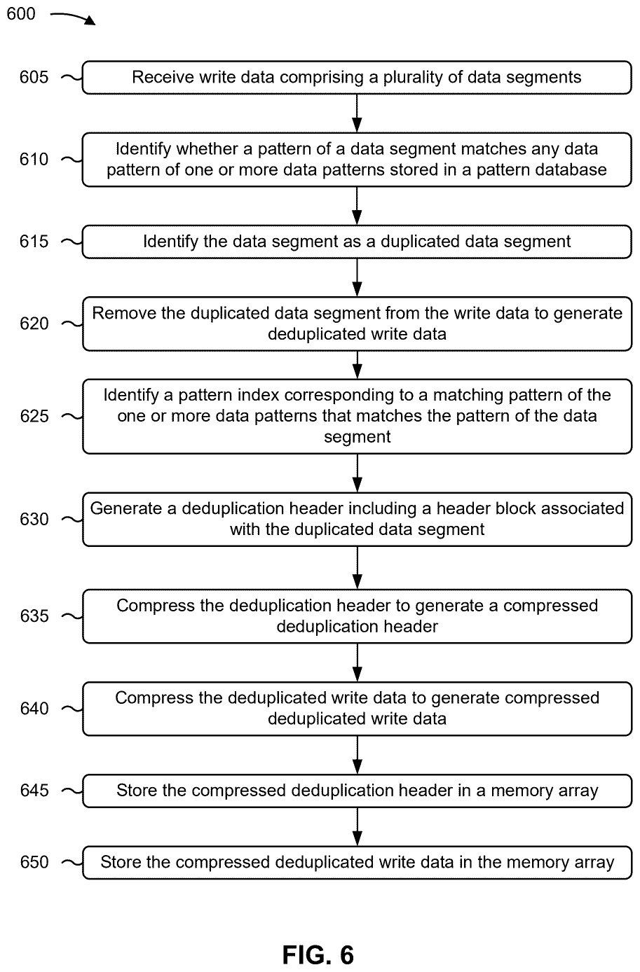

FIG. 6 is a flowchart of an example method 600 associated with providing an improved compression ratio by using pattern-based data deduplication in a memory device. In some implementations, a memory device (e.g., the memory system 110 or memory device 120) may perform or may be configured to perform the method 600. Additionally, or alternatively, one or more components of the memory device (e.g., the memory system controller 115, the local controller 125, the memory cache 202, the pattern database 204, the deduplication engine 206, the compression engine 208, the pointer table management circuit 210, the local cache 212, the encryption engine 216, the read sequencer 218, the write sequencer 220, the ECC encoder/decoder 222, the memory controller 224, and/or the memory array 226) may perform or may be configured to perform the method 600. Thus, means for performing the method 600 may include the memory device and/or one or more components of the memory device. Additionally, or alternatively, a non-transitory computer-readable medium may store one or more instructions that, when executed by the memory device, cause the memory device to perform the method 600.

As shown in FIG. 6, the method 600 may include receiving write data comprising a plurality of data segments (block 605). As further shown in FIG. 6, the method 600 may include identifying whether a pattern of a data segment matches any data pattern of one or more data patterns stored in a pattern database (block 610). As further shown in FIG. 6, the method 600 may include identifying the data segment as a duplicated data segment (block 615). As further shown in FIG. 6, the method 600 may include removing the duplicated data segment from the write data to generate deduplicated write data (block 620). As further shown in FIG. 6, the method 600 may include identifying a pattern reference corresponding to a matching pattern of the one or more data patterns that matches the pattern of the data segment (block 625). As further shown in FIG. 6, the method 600 may include generating a deduplication header including a header block associated with the duplicated data segment, wherein the header block includes the pattern reference (block 630). As further shown in FIG. 6, the method 600 may include compressing the deduplication header to generate a compressed deduplication header (block 635). As further shown in FIG. 6, the method 600 may include compressing the deduplicated write data to generate compressed deduplicated write data (block 640). As further shown in FIG. 6, the method 600 may include storing the compressed deduplication header in a memory array (block 645). As further shown in FIG. 6, the method 600 may include storing the compressed deduplicated write data in the memory array (block 650).

The method 600 may include additional aspects, such as any single aspect or any combination of aspects described below and/or described in connection with one or more other methods or operations described elsewhere herein.

Although FIG. 6 shows example blocks of a method 600, in some implementations, the method 600 may include additional blocks, fewer blocks, different blocks, or differently arranged blocks than those depicted in FIG. 6. Additionally, or alternatively, two or more of the blocks of the method 600 may be performed in parallel. The method 600 is an example of one method that may be performed by one or more devices described herein. These one or more devices may perform or may be configured to perform one or more other methods based on operations described herein.

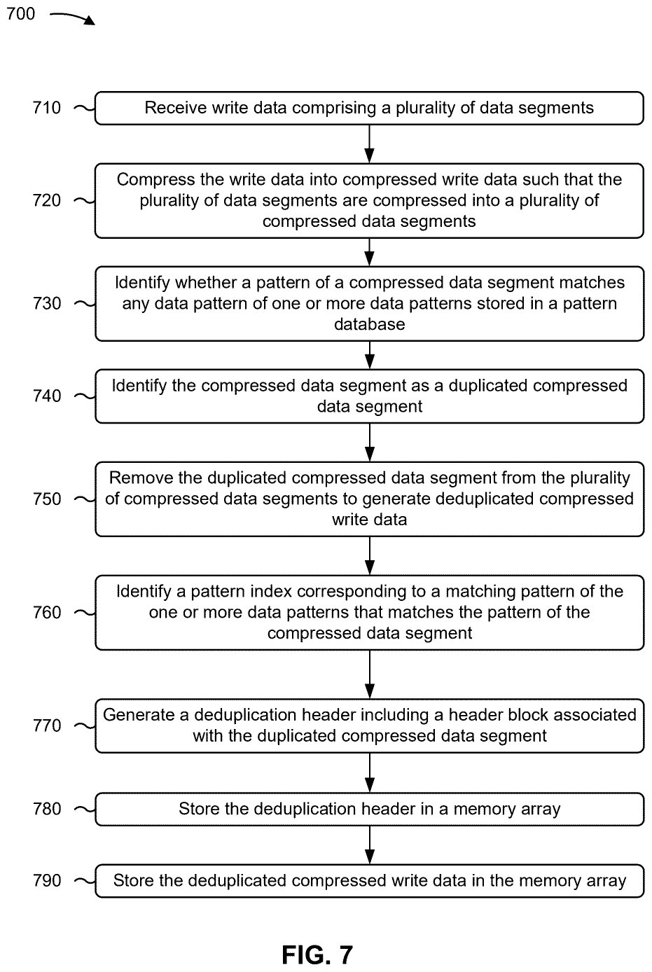

FIG. 7 is a flowchart of an example method 700 associated with providing an improved compression ratio by using pattern-based data deduplication in a memory device. In some implementations, a memory device (e.g., the memory system 110 or memory device 120) may perform or may be configured to perform the method 700. Additionally, or alternatively, one or more components of the memory device (e.g., the memory system controller 115, the local controller 125, the memory cache 202, the pattern database 204, the deduplication engine 206, the compression engine 208, the pointer table management circuit 210, the local cache 212, the encryption engine 216, the read sequencer 218, the write sequencer 220, the ECC encoder/decoder 222, the memory controller 224, and/or the memory array 226) may perform or may be configured to perform the method 700. Thus, means for performing the method 700 may include the memory device and/or one or more components of the memory device. Additionally, or alternatively, a non-transitory computer-readable medium may store one or more instructions that, when executed by the memory device, cause the memory device to perform the method 700.

As shown in FIG. 7, the method 700 may include receiving write data comprising a plurality of data segments (block 710). As further shown in FIG. 7, the method 700 may include compressing the write data into compressed write data such that the plurality of data segments are compressed into a plurality of compressed data segments (block 720). As further shown in FIG. 7, the method 700 may include identifying whether a pattern of a compressed data segment matches any data pattern of one or more data patterns stored in a pattern database (block 730). As further shown in FIG. 7, the method 700 may include identifying the compressed data segment as a duplicated compressed data segment (block 740). As further shown in FIG. 7, the method 700 may include removing the duplicated compressed data segment from the plurality of compressed data segments to generate deduplicated compressed write data (block 750). As further shown in FIG. 7, the method 700 may include identifying a pattern reference corresponding to a matching pattern of the one or more data patterns that matches the pattern of the compressed data segment (block 760). As further shown in FIG. 7, the method 700 may include generating a deduplication header including a header block associated with the duplicated compressed data segment, wherein the header block includes the pattern reference (block 770). As further shown in FIG. 7, the method 700 may include storing the deduplication header in a memory array (block 780). As further shown in FIG. 7, the method 700 may include storing the deduplicated compressed write data in the memory array (block 790).

The method 700 may include additional aspects, such as any single aspect or any combination of aspects described below and/or described in connection with one or more other methods or operations described elsewhere herein.

Although FIG. 7 shows example blocks of a method 700, in some implementations, the method 700 may include additional blocks, fewer blocks, different blocks, or differently arranged blocks than those depicted in FIG. 7. Additionally, or alternatively, two or more of the blocks of the method 700 may be performed in parallel. The method 700 is an example of one method that may be performed by one or more devices described herein. These one or more devices may perform or may be configured to perform one or more other methods based on operations described herein.

In some implementations, a memory device includes a memory cache configured to store write data received from a host device, the write data comprising a plurality of data segments; a pattern database configured to store one or more data patterns; a deduplication engine configured to: receive a data segment from the memory cache, identify whether a pattern of the data segment matches any data pattern of the one or more data patterns, based on the pattern of the data segment matching any data pattern of the one or more data patterns, identify the data segment as a duplicated data segment, remove the duplicated data segment from the write data to generate deduplicated write data, and identify a pattern index corresponding to a matching pattern of the one or more data patterns that matches the pattern of the data segment, and generate a deduplication header including a header block associated with the duplicated data segment, wherein the header block includes the pattern index; a compression engine configured to compress the deduplication header to generate a compressed deduplication header and compress the deduplicated write data to generate compressed deduplicated write data; and a memory array configured to store the compressed deduplication header and the compressed deduplicated write data.

In some implementations, a memory device includes a memory cache configured to store write data received from a host device, the write data comprising a plurality of data segments; a compression engine configured to compress the write data into compressed write data such that the plurality of data segments are compressed into a plurality of compressed data segments; a pattern database configured to store one or more data patterns; a deduplication engine configured to: receive a compressed data segment of the plurality of compressed data segments, identify whether a pattern of the compressed data segment matches any data pattern of the one or more data patterns, based on the pattern of the compressed data segment matching any data pattern of the one or more data patterns, identify the compressed data segment as a duplicated compressed data segment, remove the duplicated compressed data segment from the plurality of compressed data segments to generate deduplicated compressed write data, and identify a pattern index corresponding to a matching pattern of the one or more data patterns that matches the pattern of the compressed data segment, and generate a deduplication header including a header block associated with the duplicated compressed data segment, wherein the header block includes the pattern index; and a memory array configured to store the deduplication header and the deduplicated compressed write data.

In some implementations, a method includes receiving, by a memory cache, write data comprising a plurality of data segments; identifying, by a deduplication engine, whether a pattern of a data segment matches any data pattern of one or more data patterns stored in a pattern database; based on the pattern of the data segment matching any data pattern of the one or more data patterns, identifying, by the deduplication engine, the data segment as a duplicated data segment; removing, by the deduplication engine, the duplicated data segment from the write data to generate deduplicated write data; based on the pattern of the data segment matching any data pattern of the one or more data patterns, identifying, by the deduplication engine, a pattern index corresponding to a matching pattern of the one or more data patterns that matches the pattern of the data segment; generating, by the deduplication engine, a deduplication header including a header block associated with the duplicated data segment, wherein the header block includes the pattern index; compressing, by a compression engine, the deduplication header to generate a compressed deduplication header; compressing, by the compression engine, the deduplicated write data to generate compressed deduplicated write data; storing, by a memory controller, the compressed deduplication header in a memory array; and storing, by the memory controller, the compressed deduplicated write data in the memory array.

In some implementations, a method includes receiving, by a memory cache, write data comprising a plurality of data segments; compressing, by a compression engine, the write data into compressed write data such that the plurality of data segments are compressed into a plurality of compressed data segments; identifying, by a deduplication engine, whether a pattern of a compressed data segment matches any data pattern of one or more data patterns stored in a pattern database; based on the pattern of the compressed data segment matching any data pattern of the one or more data patterns, identifying, by the deduplication engine, the compressed data segment as a duplicated compressed data segment; removing, by the deduplication engine, the duplicated compressed data segment from the plurality of compressed data segments to generate deduplicated compressed write data; based on the pattern of the compressed data segment matching any data pattern of the one or more data patterns, identifying, by the deduplication engine, a pattern index corresponding to a matching pattern of the one or more data patterns that matches the pattern of the compressed data segment; generating, by the deduplication engine, a deduplication header including a header block associated with the duplicated compressed data segment, wherein the header block includes the pattern index; storing, by a memory controller, the deduplication header in a memory array; and storing, by the memory controller, the deduplicated compressed write data in the memory array.

In some implementations, a memory device includes a memory cache configured to store write data received from a host device, the write data comprising a plurality of data segments; a pattern database configured to store one or more data patterns; a deduplication engine configured to: receive a data segment, identify whether a pattern of the data segment matches any data pattern of the one or more data patterns, based on the pattern of the data segment matching any data pattern of the one or more data patterns, identify the data segment as a duplicated data segment, remove the duplicated data segment from the write data to generate deduplicated write data, and identify a pattern reference corresponding to a matching pattern of the one or more data patterns that matches the pattern of the data segment, and generate deduplication information including a detail associated with the duplicated data segment, wherein the detail includes the pattern reference; a compression engine configured to compress the deduplication information to generate compressed deduplication information and compress the deduplicated write data to generate compressed deduplicated write data; and a memory array configured to store the compressed deduplication information and the compressed deduplicated write data.

In some implementations, a memory device includes a memory cache configured to store write data received from a host device, the write data comprising a plurality of data segments; a compression engine configured to compress the write data into compressed write data such that the plurality of data segments are compressed into a plurality of compressed data segments; a pattern database configured to store one or more data patterns; a deduplication engine configured to: receive a compressed data segment of the plurality of compressed data segments, identify whether a pattern of the compressed data segment matches any data pattern of the one or more data patterns, based on the pattern of the compressed data segment matching any data pattern of the one or more data patterns, identify the compressed data segment as a duplicated compressed data segment, remove the duplicated compressed data segment from the plurality of compressed data segments to generate deduplicated compressed write data, and identify a pattern reference corresponding to a matching pattern of the one or more data patterns that matches the pattern of the compressed data segment, and generate deduplication information including a detail associated with the duplicated compressed data segment, wherein the detail includes the pattern reference; and a memory array configured to store the deduplication information and the deduplicated compressed write data.

In some implementations, a method includes receiving, by a memory cache, write data comprising a plurality of data segments; identifying, by a deduplication engine, whether a pattern of a data segment matches any data pattern of one or more data patterns stored in a pattern database; based on the pattern of the data segment matching any data pattern of the one or more data patterns, identifying, by the deduplication engine, the data segment as a duplicated data segment; removing, by the deduplication engine, the duplicated data segment from the write data to generate deduplicated write data; based on the pattern of the data segment matching any data pattern of the one or more data patterns, identifying, by the deduplication engine, a pattern reference corresponding to a matching pattern of the one or more data patterns that matches the pattern of the data segment; generating, by the deduplication engine, deduplication information including a detail associated with the duplicated data segment, wherein the detail includes the pattern reference; compressing, by a compression engine, the deduplication information to generate compressed deduplication information; compressing, by the compression engine, the deduplicated write data to generate compressed deduplicated write data; storing, by a memory controller, the compressed deduplication information in a memory array; and storing, by the memory controller, the compressed deduplicated write data in the memory array.

In some implementations, a method includes receiving, by a memory cache, write data comprising a plurality of data segments; compressing, by a compression engine, the write data into compressed write data such that the plurality of data segments are compressed into a plurality of compressed data segments; identifying, by a deduplication engine, whether a pattern of a compressed data segment matches any data pattern of one or more data patterns stored in a pattern database; based on the pattern of the compressed data segment matching any data pattern of the one or more data patterns, identifying, by the deduplication engine, the compressed data segment as a duplicated compressed data segment; removing, by the deduplication engine, the duplicated compressed data segment from the plurality of compressed data segments to generate deduplicated compressed write data; based on the pattern of the compressed data segment matching any data pattern of the one or more data patterns, identifying, by the deduplication engine, a pattern reference corresponding to a matching pattern of the one or more data patterns that matches the pattern of the compressed data segment; generating, by the deduplication engine, deduplication information including a detail associated with the duplicated compressed data segment, wherein the detail includes the pattern reference; storing, by a memory controller, the deduplication information in a memory array; and storing, by the memory controller, the deduplicated compressed write data in the memory array.

The foregoing disclosure provides illustration and description but is not intended to be exhaustive or to limit the implementations to the precise forms disclosed. Modifications and variations may be made in light of the above disclosure or may be acquired from practice of the implementations described herein.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

When “a component” or “one or more components” (or another element, such as “a controller” or “one or more controllers”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items and may be used interchangeably with “one or more. ” Further, as used herein, the article “the” is intended to include one or more items referenced in connection with the article “the” and may be used interchangeably with “the one or more. ” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A memory device, comprising:
a memory cache configured to store write data received from a host device, the write data comprising a plurality of data segments;
a pattern database configured to store one or more data patterns;
a deduplication engine configured to:
receive a data segment,
identify whether a pattern of the data segment matches any data pattern of the one or more data patterns,
based on the pattern of the data segment matching any data pattern of the one or more data patterns, identify the data segment as a duplicated data segment, remove the duplicated data segment from the write data to generate deduplicated write data, and identify a pattern reference corresponding to a matching pattern of the one or more data patterns that matches the pattern of the data segment, and
generate deduplication information including a detail associated with the duplicated data segment, wherein the detail includes the pattern reference;
a compression engine configured to compress the deduplication information to generate compressed deduplication information and compress the deduplicated write data to generate compressed deduplicated write data; and
a memory array configured to store the compressed deduplication information and the compressed deduplicated write data.

2. The memory device of claim 1, further comprising:
a compute express link (CXL) interface configured to receive the write data from a CXL host device.

3. The memory device of claim 1, wherein the memory array is a dynamic random access memory (DRAM) array.

4. The memory device of claim 1, wherein the deduplication information is a deduplication header that includes a header block associated with the duplicated data segment, wherein the header block includes the pattern reference.

5. The memory device of claim 1, wherein a size of the write data is a multiple of a data segment size, and the data segment size of each data segment of the plurality of data segments is 64 bytes, 128 bytes, or 256 bytes.

6. The memory device of claim 1, wherein the deduplicated write data includes a plurality of non-duplicated data segments from the plurality of data segments.

7. The memory device of claim 6, further comprising:
a pointer table management circuit configured to manage a pointer table comprising a plurality of entries, wherein each entry of the plurality of entries corresponds to a respective non-duplicated data segment of the plurality of non-duplicated data segments.

8. The memory device of claim 7, wherein the pointer table management circuit includes a local cache configured to store the pointer table.

9. The memory device of claim 7, wherein the pointer table management circuit is configured to not include an entry in the pointer table that corresponds to the duplicated data segment.

10. The memory device of claim 7, wherein each entry of the plurality of entries maps a host physical address (HPA) to a device physical address (DPA) for the respective non-duplicated data segment.

11. The memory device of claim 7, wherein the pointer table management circuit is configured to receive a host physical memory address block from the memory cache and generate the pointer table for the write data based on the host physical memory address block, and
wherein the host physical memory address block includes a host physical address (HPA) for each data segment of the plurality of data segments.

12. The memory device of claim 7, wherein the compression engine is configured to provide a length of the compressed deduplicated write data to the pointer table management circuit,
wherein the compressed deduplicated write data includes compressed non-duplicated data segments, and
wherein the pointer table management circuit is configured to, based on the length of the compressed deduplicated write data, allocate a respective media location within the memory array to each compressed non-duplicated data segment, and associate the respective media location to a corresponding entry of the plurality of entries within the pointer table.

13. The memory device of claim 12, further comprising:
a write sequencer configured to write each compressed non-duplicated data segment provided in the compressed deduplicated write data to the respective media location within the memory array.

14. The memory device of claim 1, further comprising:
an encryption engine configured to encrypt the compressed deduplication information and the compressed deduplicated write data, prior to storing the compressed deduplication information and the compressed deduplicated write data in the memory array.

15. The memory device of claim 1, wherein the compression engine is configured to compress the write data to generate compressed write data, and
wherein the memory device further comprises a controller configured to evaluate a payload size of the write data, a payload size of the deduplicated write data, a payload size of the compressed write data, and a payload size of the compressed deduplicated write data, and store one of the write data, the deduplicated write data, the compressed write data, or the compressed deduplicated write data, having a smallest payload size, in the memory array.

16. The memory device of claim 1, wherein the deduplication information includes at least one of:
a single deduplication identifier block and a single deduplication index block that includes a respective pattern reference corresponding to a single duplicated data segment,
a multiple adjacent deduplication identifier block, a multiple adjacent deduplication index block that includes a respective pattern reference corresponding to multiple adjacent duplicated data segments, and a number indicator block that includes a number of multiple adjacent duplicated data segments corresponding to the multiple adjacent deduplication identifier block and the multiple adjacent deduplication index block,
a single non-duplicated identifier block, and
a multiple adjacent non-duplicated identifier block and a number indicator block that includes a number of multiple adjacent non-duplicated data segments.

17. A memory device, comprising:
a memory cache configured to store write data received from a host device, the write data comprising a plurality of data segments;
a compression engine configured to compress the write data into compressed write data such that the plurality of data segments are compressed into a plurality of compressed data segments;
a pattern database configured to store one or more data patterns;
a deduplication engine configured to:
receive a compressed data segment of the plurality of compressed data segments,
identify whether a pattern of the compressed data segment matches any data pattern of the one or more data patterns,
based on the pattern of the compressed data segment matching any data pattern of the one or more data patterns, identify the compressed data segment as a duplicated compressed data segment, remove the duplicated compressed data segment from the plurality of compressed data segments to generate deduplicated compressed write data, and identify a pattern reference corresponding to a matching pattern of the one or more data patterns that matches the pattern of the compressed data segment, and
generate deduplication information including a detail associated with the duplicated compressed data segment, wherein the detail includes the pattern reference; and
a memory array configured to store the deduplication information and the deduplicated compressed write data.

18. The memory device of claim 17, wherein the memory array is a dynamic random access memory (DRAM) array.

19. The memory device of claim 17, wherein the deduplicated compressed write data includes a plurality of non-duplicated compressed data segments from the plurality of compressed data segments, and
wherein the memory device further comprises a pointer table management circuit configured to manage a pointer table comprising a plurality of entries, wherein each entry of the plurality of entries corresponds to a respective non-duplicated compressed data segment of the plurality of non-duplicated compressed data segments.

20. The memory device of claim 19, wherein the pointer table management circuit is configured to not include an entry in the pointer table that corresponds to the duplicated compressed data segment.

21. The memory device of claim 19, wherein each entry of the plurality of entries maps a host physical address (HPA) to a device physical address (DPA) for the respective non-duplicated compressed data segment.

22. The memory device of claim 19, wherein the pointer table management circuit is configured to receive a host physical memory address block from the memory cache and generate the pointer table for the write data based on the host physical memory address block, and
wherein the host physical memory address block includes a host physical address (HPA) for each data segment of the plurality of data segments.

23. The memory device of claim 19, wherein the deduplication engine 206 is configured to provide a length of the deduplicated compressed write data to the pointer table management circuit,
wherein the pointer table management circuit is configured to, based on the length of the deduplicated compressed write data, allocate a respective media location within the memory array to each non-duplicated compressed data segment of the plurality of non-duplicated compressed data segments, and associate the respective media location to a corresponding entry of the plurality of entries within the pointer table, and
wherein the memory device further comprises a write sequencer configured to write each non-duplicated compressed data segment provided in the deduplicated compressed write data to the respective media location within the memory array.

24. A method, comprising:
receiving, by a memory cache, write data comprising a plurality of data segments;
identifying, by a deduplication engine, whether a pattern of a data segment matches any data pattern of one or more data patterns stored in a pattern database;
based on the pattern of the data segment matching any data pattern of the one or more data patterns, identifying, by the deduplication engine, the data segment as a duplicated data segment;
removing, by the deduplication engine, the duplicated data segment from the write data to generate deduplicated write data;
based on the pattern of the data segment matching any data pattern of the one or more data patterns, identifying, by the deduplication engine, a pattern reference corresponding to a matching pattern of the one or more data patterns that matches the pattern of the data segment;
generating, by the deduplication engine, deduplication information including a detail associated with the duplicated data segment, wherein the detail includes the pattern reference;
compressing, by a compression engine, the deduplication information to generate compressed deduplication information;
compressing, by the compression engine, the deduplicated write data to generate compressed deduplicated write data;
storing, by a memory controller, the compressed deduplication information in a memory array; and
storing, by the memory controller, the compressed deduplicated write data in the memory array.

25. A method, comprising:
receiving, by a memory cache, write data comprising a plurality of data segments;
compressing, by a compression engine, the write data into compressed write data such that the plurality of data segments are compressed into a plurality of compressed data segments;
identifying, by a deduplication engine, whether a pattern of a compressed data segment matches any data pattern of one or more data patterns stored in a pattern database;
based on the pattern of the compressed data segment matching any data pattern of the one or more data patterns, identifying, by the deduplication engine, the compressed data segment as a duplicated compressed data segment;
removing, by the deduplication engine, the duplicated compressed data segment from the plurality of compressed data segments to generate deduplicated compressed write data;
based on the pattern of the compressed data segment matching any data pattern of the one or more data patterns, identifying, by the deduplication engine, a pattern reference corresponding to a matching pattern of the one or more data patterns that matches the pattern of the compressed data segment;
generating, by the deduplication engine, deduplication information including a detail associated with the duplicated compressed data segment, wherein the detail includes the pattern reference;
storing, by a memory controller, the deduplication information in a memory array; and
storing, by the memory controller, the deduplicated compressed write data in the memory array.
